(19) United States
(12) Patent Application Publication
(10) Pub. No.: US 2006/0101208 A1
(43) Pub. Date: May 11, 2006

(54) Method and apparatus for handling non-temporal memory accesses in a cache

(75) Inventor: Sailesh Kottapalli, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/985,484

(22) Filed: Nov. 9, 2004

(51) Int. Cl. G06F 12/00

(52) U.S. Cl. 711/134

(57) ABSTRACT

A method and apparatus for supporting temporal data and non-temporal data memory accesses in a cache is disclosed. In one embodiment, a specially selected way in a set is generally used for non-temporal data memory accesses. A non-temporal flag may be associated with this selected way. In one embodiment, cache lines from memory accesses including a non-temporal hint may be generally placed into the selected way, and the non-temporal flag then set. When a temporal data cache line is to be loaded into a set, it may overrule the normal replacement method when the non-temporal flag is set, and be loaded into that selected way.

### FIELD

The present disclosure relates generally to microprocessors that use cache line replacement methods upon a miss to a cache, and more specifically to microprocessors that also use instructions that give hints that a particular memory access is to non-temporal data.

### BACKGROUND

Programmers may categorize the data that is to be processed in several different manners. One useful categorization may be between data that is temporal and data that is non-temporal. Here data categorized as temporal generally may be expected to be accessed several times over a period of time, whereas data categorized as non-temporal may generally be expected to only be accessed once during a corresponding period of time, or accessed over a short burst followed by a period of no activity. The hardware may learn about the categorization by receiving a non-temporal hint given by a memory access instruction.

Non-temporal data may impact system performance when brought into a cache. A cache line containing non-temporal data may need to evict a cache line containing temporal data. Here data that may be accessed multiple times will be evicted in favor of data that may only be accessed once or may only be accessed in a short burst across all the elements of the same line. It is likely that the evicted temporal data will have to be brought back into the cache from memory. This effect may be seen most strongly in caches that do not use priority-based line replacement methods. Examples of these non-priority-based line replacement methods are as random (or pseudo-random) replacement, and round-robin replacement. However, this effect may still be seen in priority-based cache line replacement methods such as the least-recently-used (LRU) cache line replacement method.

It is possible to mitigate this effect by declaring certain portions of memory as “uncacheable”. This may be performed by system software during system initialization. Data stored there will be accessed directly by the processor and will not become resident in the cache. However, using data from uncacheable memory areas may produce new impacts on system performance. One example of these impacts on system performance may arise from the need to make a separate access to system memory for each data word stored in uncacheable memory. This situation may occur when performing a checksum operation over a large block of data in order to determine whether there have been any changes in the data since the last checksum was calculated. In contrast, when accessing cacheable (i.e. not uncacheable) memory, the memory accesses will bring in one or more cache lines from memory. Each cache line will generally include numerous data words, and may need only make one access to system memory per cache line. In many cases, data required by a program may be stored in sequential memory addresses, or at least in memory addresses that would be spanned by a cache line. In these cases, accessing a considerable number of individual data words from uncacheable memory may take a much longer period of time than accessing the same number of individual data words in the form of cache lines resident in a cache.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a multi-core processor including a last-level cache, according to one embodiment.

FIG. 2 is a memory diagram showing uncacheable and cacheable regions, according to one embodiment.

FIG. 3 is a schematic diagram of a cache with non-temporal flags, according to one embodiment.

FIG. 4 is a flowchart diagram of a method for servicing temporal data and non-temporal data memory requests in a cache, according to one embodiment of the present disclosure.

FIG. 5 is a flowchart diagram of a method for servicing temporal data and non-temporal data memory requests in a cache, according to another embodiment of the present disclosure.

FIG. 6 is a flowchart diagram of a method for servicing temporal data and non-temporal data memory requests in a cache, according to another embodiment of the present disclosure.

FIG. 7A is a schematic diagram of a system including processors with caches, according to one embodiment of the present disclosure.

FIG. 7B is a schematic diagram of a system including processors with caches, according to another embodiment of the present disclosure.

### DETAILED DESCRIPTION

The following description includes techniques for an improved cache line replacement method for use in multi-level caches. In the following description, numerous specific details such as logic implementations, software module allocation, bus and other interface signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

In certain embodiments the invention is disclosed in the form of caches present in multi-core implementations of Pentium® compatible processor such as those produced by Intel (Corporation. However, the invention may be practiced in the caches present in other kinds of processors, such as an Itanium® (Processor Family compatible processor or an X-Scale® (family compatible processor.

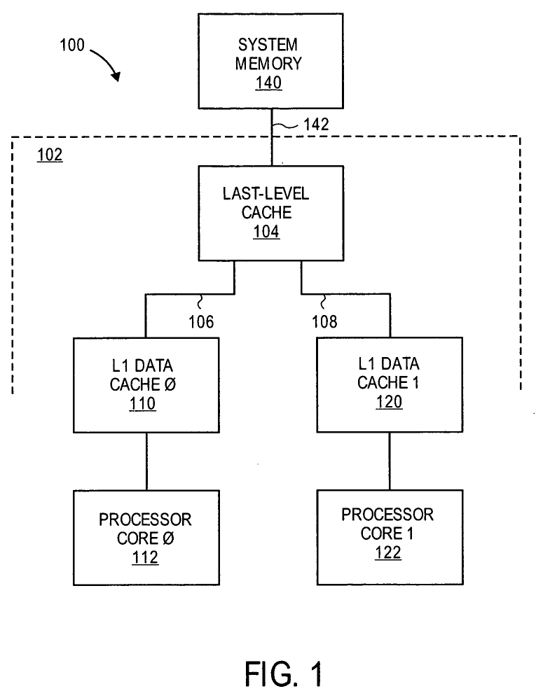

Referring now to FIG. 1, a schematic diagram of a multi-core processor 102 including a last-level cache 104 is shown, according to one embodiment. Shown in this embodiment is the case which uses two processor cores, processor core 0 112 and processor core 1 122. In other embodiments, a single processor core or more than two processor cores may be used. By its title, last-level cache 104 generally indicates that this is the cache farthest from the processor cores 112, 122 and closest to system memory 140. However, in some embodiments there may be higher level caches between the multi-core processor 102 and system memory 140.

Last-level cache 104 may be configured as a unitary cache (both data and instructions) or as a data cache. The lowest-level caches, level one (L1) data cache 0 110 and L1 data cache 1 120, are shown directly below last-level cache 104 in the cache hierarchy of multi-core processor. In other embodiments, there may be additional caches, such as a level two (L2) cache, configured between the L1 data caches 110, 120 and the last-level cache 104. Last-level cache 104 generally includes an interface circuit which permits data transmission between last-level cache 104 and system memory 140 over an interface 142. In various embodiments interface 142 may be a multi-drop bus or a point-to-point interface. In other embodiments, the processor cores may have independent last-level caches instead of the shared last-level cache 104.

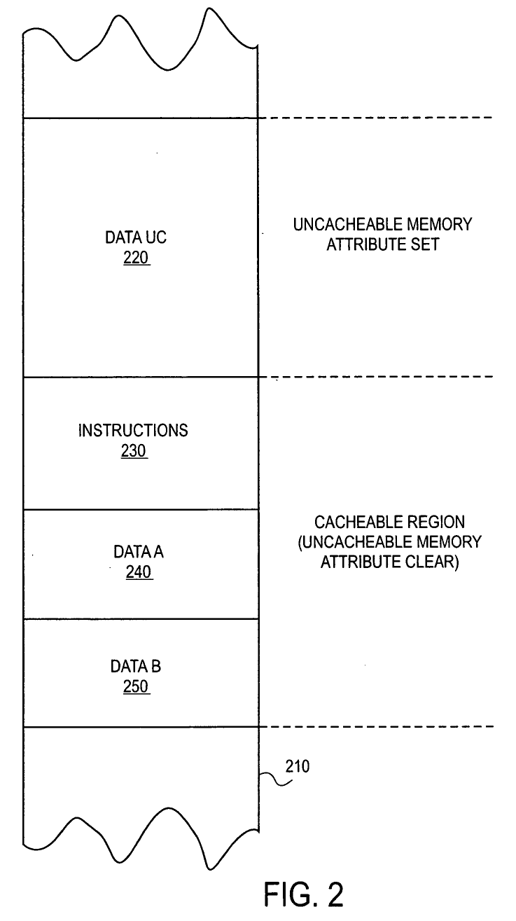

Referring now to FIG. 2, a memory diagram showing uncacheable and cacheable regions, according to one embodiment. In memory 210, various regions may be established as capable of being accessed by a processor through the cache (cacheable) or being accessed by the processor directly, avoiding the cache (uncacheable). In one embodiment, an uncacheable attribute for a region in memory may be set or cleared under software control. In the FIG. 2 example, various data that may be use infrequently by the software may be placed into a region of memory 210 with the uncacheable memory attribute set (data uncacheable 220). Such data may be one form of non-temporal data. Memory accesses to data uncacheable 220 may avoid cache line evictions in a lower level cache. Another region of memory 210 may have the uncacheable memory attribute clear, and therefore be treated as cacheable. Instructions 230 may be placed into the cacheable region (with uncacheable memory attribute clear). Data that may be accessed repeatedly by software, which may be referred to as temporal data, may also be placed into the cacheable region (with uncacheable memory attribute clear), such as data A 240.

Another case may be data B 250 that may be accessed infrequently, but when a particular data word is accessed so may its neighbors. This may be another example of non-temporal data. An example of such data may be a string whose checksum may be evaluated. If data B 250 were placed into the uncacheable region of memory (where the uncacheable memory attribute is set), a separate memory access would need to be performed to access each data word. Since data B 250 is shown placed into the cacheable region of memory (where the uncacheable memory attribute is clear), an entire cache line may be brought into low-level cache. This provides for improved data latency, since a particular data word's neighboring data words would be brought in with the cache line. Fewer accesses to system memory would need to be performed. However, since bringing the cache line into lower-level cache may require an eviction, the improved data latency for the non-temporal data may cause increased latency for other temporal data. For this reason, the present disclosure discusses several techniques that may reduce the latency impacts on temporal data due to evictions when non-temporal data is cached.

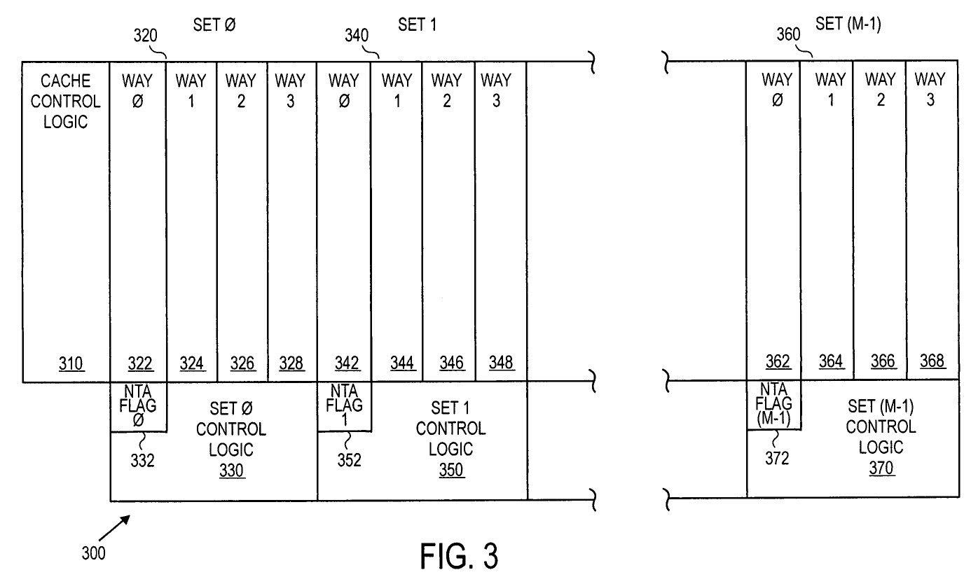

Referring now to FIG. 3, a schematic diagram of a cache 300 with non-temporal flags is shown, according to one embodiment. Cache 300 may in some embodiments be the last-level cache 104 of FIG. 1. In other embodiments, cache 300 may be an intermediate-level cache or a lowest-level cache. In an N-way set associative cache, each of the M sets has N places to hold a cache line, each place being called a “way”. Any particular cache line in system memory may only be loaded into a particular one of the M sets, but that particular cache line may generally be loaded into any of the N ways of that particular set. Cache 300 is shown as a four-way set associative cache, but in other embodiments other values for N may be used. (Actual caches are generally implemented with many more ways than the four shown here.) As a boundary case, a fully-associative cache may be considered an N-way set associative cache with only one set.

FIG. 3 shows cache 300 with M sets, labeled set 0 320 through set (M−1) 360. The cache 300 may include a cache control logic 310 which may include circuitry to interface with external interfaces, respond to snoop requests, forward requests to system memory on a cache line miss, and forward cache lines to lower-level caches on a cache line hit. In each set, the four ways are shown as way 0 through way 3, along with a corresponding set control logic.

Each set control logic may include circuitry to identify a replacement method when new cache lines need to be added to the set, generally as a result as a cache “miss” to that set. This replacement method may identify which way contains a cache line that is to be overwritten by the new cache line. This identified cache line may be called a “replacement candidate” or “victim”. The replacement method may in varying embodiments be made by identifying a least-recently-used cache line (LRU), by another usage-based method, by identifying a replacement candidate randomly or pseudo-randomly, or by identifying a replacement candidate by a round-robin method. All of these replacement methods may initially seek invalid cache lines, and only proceed to their specific method when no invalid cache lines are found. In other embodiments, other replacement methods may be used. In yet other embodiments, the cache line replacement functions performed in FIG. 3 by the set control logics 330, 350, 370 may be performed instead by a portion of cache control logic 310 in those cases where further logical block divisions by function are not made.

When a cache line containing non-temporal data is brought into a way, it evicts the current contents of that way. If the current contents of that way are temporal data, then this temporal data is likely to be accessed in the near future and would then need to be reloaded into the cache. System performance may be improved if the victim evicted were instead either an invalid cache line or a non-temporal data cache line.

Therefore, in one embodiment, the set control logic may modify (or ignore) the general replacement policy and load non-temporal data cache lines into a specially selected way of the set. For example, the selected way for set 1 340 may be way 0 342. In other embodiments, any other way could have been selected. The identification of the specially selected way may be maintained for a considerable period of time, if not permanently. When set 1 control logic 350 determines that a non-temporal data cache line will be placed into set 1 340, it may evict the cache line in way 0 342 and replace it with the non-temporal data cache line.

When a non-temporal data cache line is loaded into the selected way in a set, a corresponding non-temporal all (NTA) flag may be set. Continuing the example above, when the non-temporal cache line is loaded into way 0 3442 of set 1 340, the set 1 control logic 350 may set NTA flag 1 352. This single flag may indicate both the presence and the location of a non-temporal data cache line in set 1 340. It indicates the location because the non-temporal data cache line may only be loaded into the selected way, in this example way 0 342 of set 1 340. When the selected way of a set no longer contains a non-temporal data cache line, the corresponding NTA flag may be cleared. It may be noted that the addition of the NTA flags requires only one additional bit of replacement state per set in order to indicate the presence of a non-temporal cache line.

In one embodiment, the set control logic may determine that an incoming cache line may be a non-temporal data cache line because the memory access instruction causing the loading of that cache line may contain an NTA hint. In other embodiments, other methods of determining that an incoming cache line may be a non-temporal data cache line may be used.

When a temporal data cache line is to be loaded into the set, the set control logic may examine the state of the corresponding NTA flag. If the NTA flag is not set, then the victim identified by the normal replacement method may be evicted and the new temporal data cache line may be loaded into the way previously occupied by the victim. However, if the NTA flag is set, then the normal replacement method may in some cases be overruled, and the new temporal data cache line may instead be loaded into the selected way. The previous contents of the selected way, presumed to be a non-temporal data cache line, may in these instances be evicted. In other cases, where the incoming temporal data cache line has been determined to be of special importance, it may be determined that it would be better not to load it into the non-temporal way, and to proceed with the normal replacement method.

If cache 300 is not a lowest-level cache, there may be situations when a temporal data request issued by a lower-level cache may hit in cache 300. For example, a temporal data request may hit on the selected way, such as way 0 342 of set 1 340. If the NTA flag 1 352 is not set, then no special action need be taken and the cache line contained in way 0 342 of set 1 340 may be returned to the lower-level cache. When NTA flag 1 352 is set, then the NTA flag 1 352 may be cleared together with returning the cache line contained in way 0 342 of set 1 340 to the lower-level cache. This causes the NTA flag 1 352 to correctly convey the indication that the contents of way 0 342, previously a non-temporal data cache line, should now be considered to be a temporal data cache line.

Additional enhancements to the function of cache 300 may be implemented in other embodiments. For example, the existence of a way in the set containing an invalid cache line, as determined by a cache coherency protocol, may be considered for placing an incoming cache line into that way. For loading a temporal data cache line, it may be better to first load the temporal data cache line into the way containing an invalid cache line. If no such invalid cache line exists, then if the NTA flag is set load the temporal data into the selected way and clear the NTA flag. If no such invalid cache line exists, and if the NTA flag is not set, then load the temporal data into the way selected by the normal replacement method.

For loading a non-temporal data cache line, it may be better to first load the non-temporal data cache line into the way containing an invalid cache line and take no action with regards the state of the NTA flag. If no such invalid cache line exists, then load the non-temporal data cache line into the selected way and set the NTA flag.

In another embodiment, an enhancement may be made by considering the existence of a priority cache line. Here a “priority” cache line may mean a cache line that has been determined to be one that should preferably stay resident in the cache to benefit performance. Such a priority cache line may be determined by the normal replacement method. In the case of a least-recently-used (LRU) or pseudo-LRU replacement method, the priority cache line may be the one identified as the most-recently-used (MRU) cache line. In other embodiments, other kinds of priority cache lines may be determined.

If a priority data cache line is resident in the selected way of the set, it may cause a performance degradation if the priority cache line is evicted in favor of loading a non-temporal cache line. Therefore, in one embodiment if a priority data cache line is resident in the selected way of the set, then an incoming non-temporal data cache line should be redirected to another way other than the selected way. This way may be chosen by the normal replacement method, or some other method. As the non-temporal data cache line will not be loaded into the selected way of the set, the corresponding NTA flag should not be set.

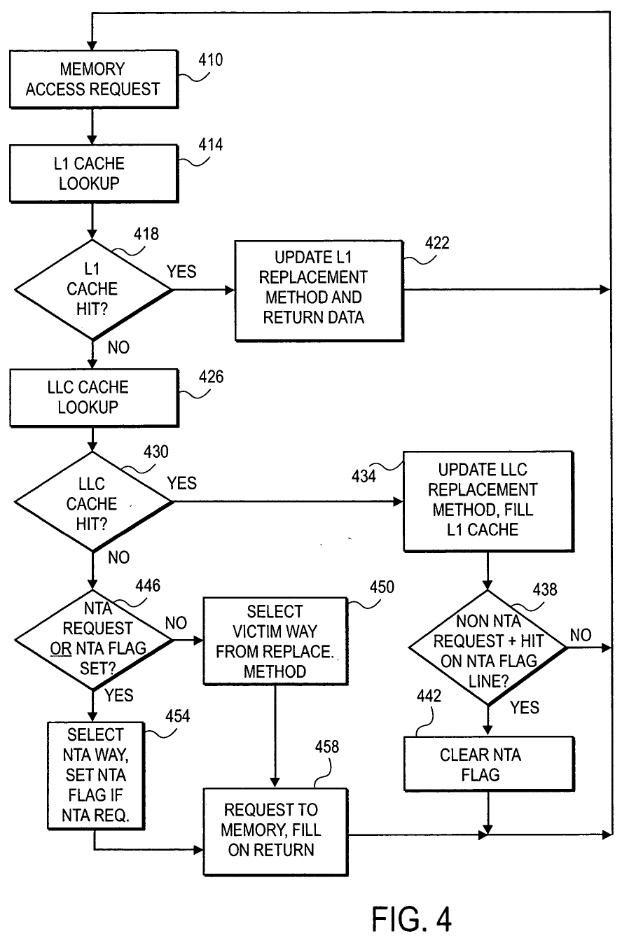

Referring now to FIG. 4, a flowchart diagram of a method for servicing temporal data and non-temporal data memory requests in a cache is shown, according to one embodiment of the present disclosure. In block 410 a memory access request is issued by the processor. The level one (L1) cache is searched for the requested data in block 414. Then in decision block 418 it is determined whether or not the requested data is resident in the L1 cache (i.e. a “cache hit”). If so, then the process exits via the YES path and in block 422 the requested data is supplied to the processor. At this time the L1 cache's replacement method may be updated for the set in which the requested data was found. The process then repeats at block 410.

If in decision block 418 it is determined that the requested data is not present in the L1 cache, then the process exits via the NO path. In block 426 the requested data is searched for in a last-level cache (LLC). Then in decision block 430 it is determined whether or not the requested data is resident in the LLC cache. If so, then the process exits via the YES path and in block 434 the requested data is supplied to the L1 cache. If so, then the process exits via the YES path and in block 434 the requested data is supplied to the L1 cache. At this time the LLC cache's replacement method may be updated for the set in which the requested data was found.

In decision block 438 it is determined whether or not the requested data was both from a temporal data request (memory access instruction without a non-temporal hint), and that the hit in the LLC cache was to a special way whose NTA flag is set. If not, then the process exits via the NO path and the process repeats at block 410. If so, then the process exits via the YES path and in block 442 the corresponding NTA flag is cleared. Then the process repeats at block 410.

If in decision block 430 it is determined that the requested data is not resident in the LLC cache, then the process exits via the NO path. In decision block 446, it is determined if the requested data was from a non-temporal data request (from a memory access instruction with a non-temporal hint), or if the NTA flag of the corresponding set was set (or in some cases both). If neither, then the process exits via the NO path and in block 450 a way with the victim selected by the normal replacement method is identified to receive the requested data cache line. If, however, either the requested data was from a non-temporal data request, or the NTA flag of the corresponding set was set, then the process exits via the YES path. Then in block 454 the special way of the set is identified to receive the requested data cache line. If the requested data was from a non-temporal data request, then the NTA flag will be set. If the requested data was from a temporal data request, then the NTA flag will be cleared.

When the way to be used to receive the requested data cache line is identified either in block 450 or block 454, then the process enters block 458. There the memory access request is sent on to system memory. When the requested data returns from memory, the way identified in either block 450 or block 454 is filled, and the requested data is also sent down to the lower-level caches and to the processor. The process then repeats at block 410.

In other embodiments, the FIG. 4 process may be expanded to include one or more intermediate-level caches between the L1 cache and LLC cache discussed. In some of these embodiments, the decision made in decision block 446, either whether the requested data was from a non-temporal data request or if the NTA flag of the corresponding set was set, may be made for a lower-level cache relative to the LLC. A corresponding way for each set in one of these lower-level caches may be identified for loading with the requested data when the corresponding decision block exits along a YES path.

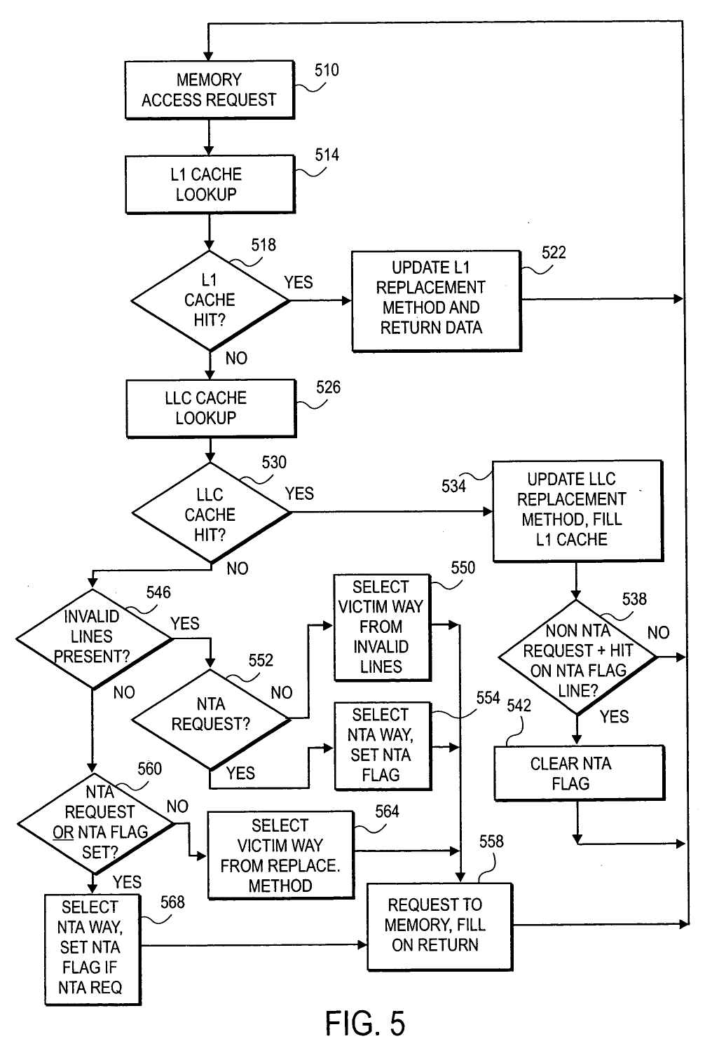

Referring now to FIG. 5, a flowchart diagram of a method for servicing temporal data and non-temporal data memory requests in a cache is shown, according to another embodiment of the present disclosure. Many of the procedures followed in the FIG. 5 process may be equivalent to similarly-named blocks in the FIG. 4 process. However, the FIG. 5 process differs when following along the NO path leading from decision block 530, where it is determined whether or not the requested data is resident in the LLC cache.

In decision block 546, it may be determined whether one or more ways in the corresponding set are flagged as invalid by the cache coherency protocol. If not, then the process exits decision block 546 along the NO path and the remaining process is similar to that of the FIG. 4 embodiment. In decision block 560, it is determined if the requested data was from a non-temporal data request (from a memory access instruction with a non-temporal hint), or if the NTA flag of the corresponding set was set (or in some cases both). If neither, then the process exits via the NO path and in block 564 a way with the victim selected by the normal replacement method is identified to receive the requested data cache line. If, however, either the requested data was from a non-temporal data request, or the NTA flag of the corresponding set was set, then the process exits via the YES path. Then in block 568 the special way of the set is identified to receive the requested data cache line. If the requested data was from a non-temporal data request, then the NTA flag will be set. If the requested data was from a temporal data request, then the NTA flag will be cleared.

However, if in decision block 546 it is determined that one or more ways in the corresponding set are flagged as invalid by the cache coherency protocol, then the process exits decision block 546 along the YEW path. In decision block 552, it is determined if the memory request is a non-temporal request. If not, the process exits along the NO path, and in block 550 one of the ways with a cache line flagged as invalid is identified to receive the requested data cache line. If so, then the process exits along the YES path, and in block 554 the special way of the set is identified to receive the requested data cache line and the NTA flag will be set.

When the way to be used to receive the requested data cache line is identified either in block 550, block 554, block 564, or block 568, the process then enters block 558. There the memory access request is sent on to system memory. When the requested data returns from memory, the identified way is filled, and the requested data is also sent down to the lower-level caches and to the processor. The process then repeats at block 510.

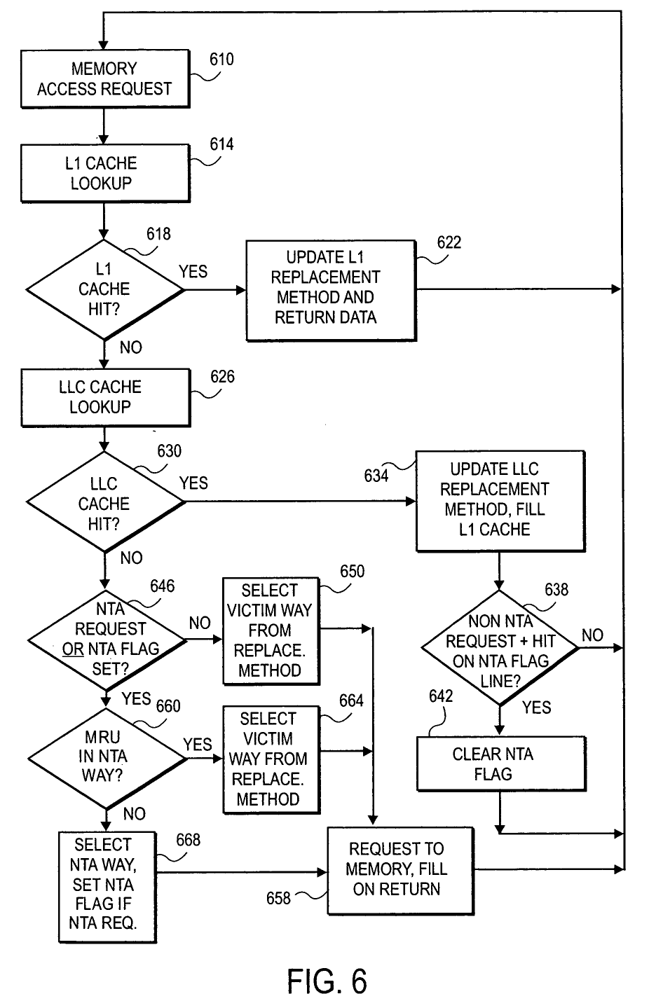

Referring now to FIG. 6, a flowchart diagram of a method for servicing temporal and non-temporal memory requests in a cache is shown, according to another embodiment of the present disclosure. Many of the procedures followed in the FIG. 6 process may be equivalent to similarly-named blocks in the FIG. 4 process. However, the FIG. 6 process differs when following along the YES path leading from decision block 646, where it is determined if the requested data was from a non-temporal data request or if the NTA flag of the corresponding set was set.

In decision block 660, it may be determined whether a most-recently used (MRU) cache line is resident in the selected way. (It may be noted that if this is the case, then the NTA flag will not be set.) In other embodiments, the determination may be for another kind of priority cache line. If not, then the process exits decision block 660 along the NO path, and in block 668 the special way of the set is identified to receive the requested data cache line. If the requested data was from a non-temporal data request, then the NTA flag will be set. If the requested data was from a temporal data request, then the NTA flag will be cleared.

However, if in decision block 660 it is determined that a MRU cache line is resident in the selected way, then the process exits via the YES path. In block 664, the special way of the set is not identified to receive the requested data cache line, and instead a way with the victim selected by the normal replacement method is identified to receive the requested data cache line. This may prevent a non-temporal data cache line from evicting the MRU cache line. In block 664, no action is taken to set or clear the corresponding NTA flag. The process then proceeds to block 658 as in the other circumstances.

FIGS. 4, 5, and 6 have shown several embodiments of the cache line replacement method of the present disclosure. It should be noted that each have emphasized for clarity certain aspects of the cache line replacement method, such as examining invalid cache lines or cache lines of high priority, and that these aspects may in other embodiments be combined in other fashions to create further embodiments of the cache line replacement method.

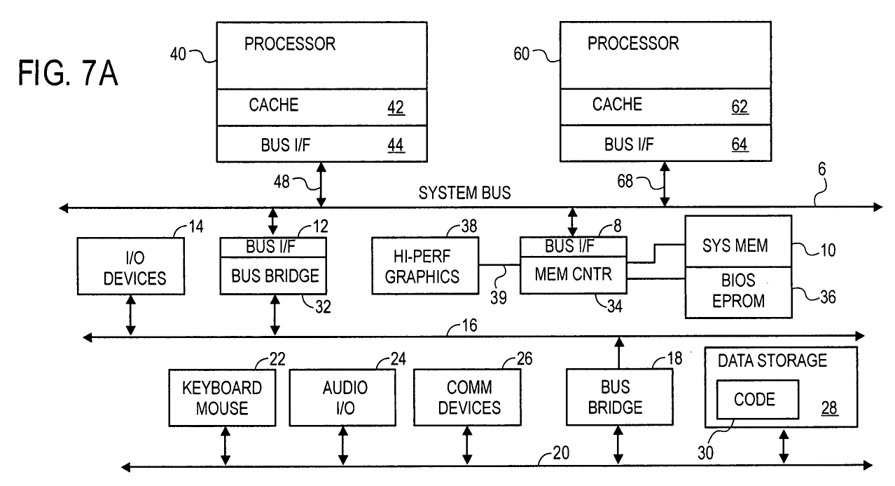

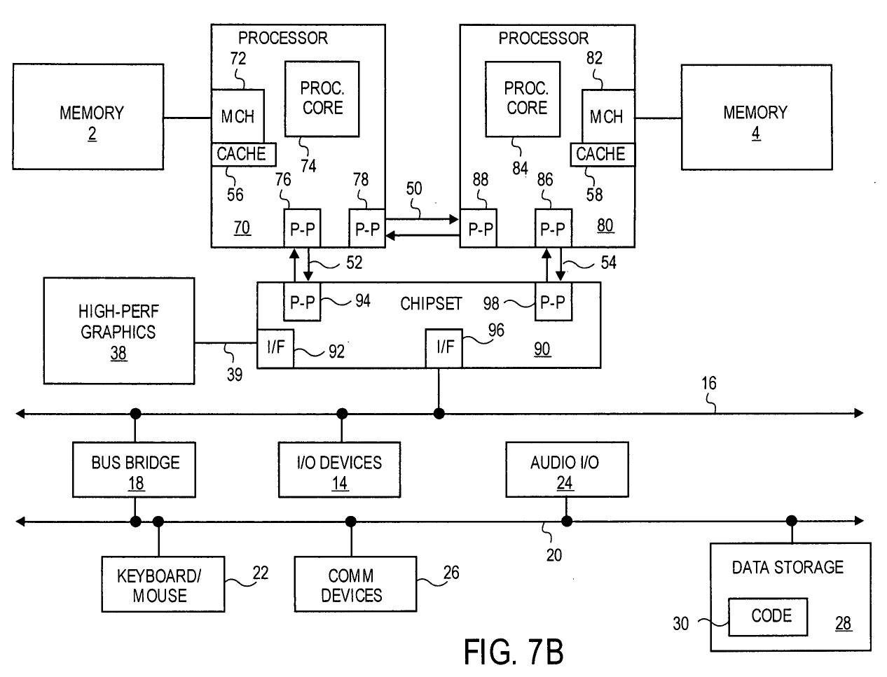

Referring now to FIGS. 7A and 7B, schematic diagrams of systems including processors with caches supporting temporal data and non-temporal data accesses are shown, according to two embodiments of the present disclosure. The FIG. 7A system generally shows a system where processors, memory, and input/output devices are interconnected by a system bus, whereas the FIG. 7B system generally shows a system where processors, memory, and input/output devices are interconnected by a number of point-to-point interfaces.

The FIG. 7A system may include several processors, of which only two, processors 40, 60 are shown for clarity. Processors 40, 60 may include last-level caches 42, 62. The FIG. 7A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other busses may be used. In some embodiments memory controller 34 and bus bridge 32 may collectively be referred to as a chipset. In some embodiments, functions of a chipset may be divided among physical chips differently than as shown in the FIG. 7A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct data from system memory 10 to the high-performance graphics circuit 38 across high-performance graphics interface 39.

The FIG. 7B system may also include several processors, of which only two, processors 70, 80 are shown for clarity. Processors 70, 80 may each include a local memory controller hub (MCH) 72, 82 to connect with memory 2, 4. Processors 70, 80 may also include last-level caches 56, 58. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 7A system, bus bridge 32 may permit data exchanges between system bus 6 and bus 16, which may in some embodiments be a industry standard architecture (ISA) bus or a peripheral component interconnect (PCI) bus. In the FIG. 7B system, chipset 90 may exchange data with a bus 16 via a bus interface 96. In either system, there may be various input/output (I/O) devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A cache, comprising:
a first way in a set of said cache;
a first flag associated with said first way; and
a control logic to place a first cache line from a first memory access with non-temporal hint set into said first way.

2. The cache of claim 1, wherein said control logic to set said first flag when placing said first cache line into said first way.

3. The cache of claim 2, wherein said control logic to place a second cache line from a second memory access without non-temporal hint into a second way of said set selected by a replacement method when said first flag is not set.

4. The cache of claim 2, wherein said control logic to place a second cache line from a second memory access without non-temporal hint into said first way of said set when said first flag is set.

5. The cache of claim 4, wherein said control logic to further clear said first flag.

6. The cache of claim 1, wherein said control logic to clear said first flag when a second memory access without non-temporal hint has a cache hit on said first way when said first flag is set.

7. The cache of claim 1, wherein said control logic to place a third cache line from a third memory access with non-temporal hint clear into a second way marked invalid.

8. The cache of claim 1, wherein said control logic to place said first cache line from said first memory access with non-temporal hint set into a second way, when said first way contains a priority cache line.

9. The cache of claim 8, wherein said priority cache line is a most-recently-used cache line.

10. A method, comprising:
determining whether a first memory access that misses in a set has non-temporal hint;
if so, then placing a first cache line corresponding to said first memory access into a first way; and
if not, then placing said first cache line into a second way selected by a replacement method.

11. The method of claim 10, further comprising setting a first flag when said determining whether said first memory access that misses in a set has said non-temporal hint determines that said non-temporal hint is present.

12. The method of claim 11, further comprising placing a second cache line corresponding to a second memory access without non-temporal hint into a third way selected by said replacement method when said first flag is not set.

13. The method of claim 11, further comprising placing a second cache line corresponding to a second memory access without non-temporal hint into said first way when said first flag is set.

14. The method of claim 13, further comprising clearing said first flag.

15. The method of claim 10, further comprising clearing said first flag when a second memory access without non-temporal hint hits on said first way when said first flag is set.

16. The method of claim 10, further comprising placing a third cache line from a third memory access without a non-temporal hint into a second way marked invalid.

17. The method of claim 14, further comprising placing said cache line from said first memory access into a second way when said first way contains a priority cache line, regardless of presence of said non-temporal hint.

18. The method of claim 17, wherein said priority cache line is a most-recently-used cache line.

19. A system, comprising:
a cache including a first way in a set of said cache, a first flag associated with said first way, and a control logic to place a first cache line from a first memory access with non-temporal hint set into said first way;
an audio input/output logic; and
an interface to couple said cache to said audio input-output logic.

20. The system of claim 19, wherein said control logic to set said first flag when placing said first cache line into said first way.

21. The system of claim 20, wherein said control logic to place a second cache line from a second memory access without non-temporal hint into a second way of said set selected by a replacement method when said first flag is not set.

22. The system of claim 20, wherein said control logic to place a second cache line from a second memory access without non-temporal hint into said first way of said set when said first flag is set.

23. The system of claim 22, wherein said control logic to further clear said first flag.

24. The system of claim 19, wherein said control logic to clear said first flag when a second memory access without non-temporal hint has a cache hit on said first way when said first flag is set.

25. The system of claim 19, wherein said control logic to place a third cache line from a third memory access with non-temporal hint clear into a second way marked invalid.

26. The system of claim 19, wherein said control logic to place said first cache line from said first memory access with non-temporal hint set into a second way, when said first way contains a priority cache line.

27. The system of claim 26, wherein said priority cache line is a most-recently-used cache line.

28. An apparatus, comprising:
means for determining whether a first memory access that misses in a set has non-temporal hint;
means for if so, then placing a first cache line corresponding to said first memory access into a first way; and
means for if not, then placing said first cache line into a second way selected by a replacement method.

29. The apparatus of claim 28, further comprising means for setting a first flag when said determining whether said first memory access that misses in a set has said non-temporal hint determines that said non-temporal hint is present.

30. The apparatus of claim 29, further comprising means for placing a second cache line corresponding to a second memory access without non-temporal hint into a third way selected by said replacement method when said first flag is not set.

31. The apparatus of claim 29, further comprising means for placing a second cache line corresponding to a second memory access without non-temporal hint into said first way when said first flag is set.

32. The apparatus of claim 31, further comprising clearing said first flag.

33. The apparatus of claim 28, further comprising means for clearing said first flag when a second memory access without non-temporal hint hits on said first way when said first flag is set.

34. The apparatus of claim 28, further comprising means for placing a third cache line from a third memory access without a non-temporal hint into a second way marked invalid.

35. The apparatus of claim 34, further comprising means for placing said cache line from said first memory access into a second way when said first way contains a priority cache line, regardless of presence of said non-temporal hint.

36. The apparatus of claim 35, wherein said priority cache line is a most-recently-used cache line.
